(19) United States
(12) Patent Application Publication
(10) Pub. No.: US 2012/0009381 A1
(43) Pub. Date: Jan. 12, 2012

(54) CARBON NANOTUBE HONEYCOMB AND METHODS OF MAKING AND USE THEREOF

(75) Inventors: Mei Zhang, Tallahassee, FL (US); Elizabeth Morley, Tallahassee, FL (US); Richard Liang, Tallahassee, FL (US); Chuck Zhang, Tallahassee, FL (US); Ben Wang, Tallahassee, FL (US)

(73) Assignee: Florida State University Research Foundation, Tallahassee, FL (US)

(21) Appl. No.: 13/174,454

(22) Filed: Jun. 30, 2011

Related U.S. Application Data
(60) Provisional application No. 61/362,500, filed on Jul. 8, 2010.

(51) Int. Cl. B32B 3/12; B32B 7/12; B82Y 40/00

(52) U.S. Cl. 428/118; 156/197; 428/116; 977/900

(57) ABSTRACT

Materials that have a honeycomb structure are provided that are formed, at least in part, from carbon nanotube sheets. Methods are also provided for making these materials, including the expansion method, in which an adhesive is applied to carbon nanotube sheets, which are then stacked and expanded to form the honeycomb structure, or a corrugated method, in which an adhesive is applied to corrugated sheets, which are then stacked to form the honeycomb structure.

### CROSS-REFERENCE TO RELATED APPLICATIONS

Priority is claimed to U.S. Provisional Application No. 61/362,500, filed Jul. 8, 2010. The provisional application is incorporated herein by reference.

### BACKGROUND

Materials with honeycomb structures are widely used in modern engineering. Generally, materials with honeycomb structures are well-known periodic materials, in which a prismatic cell is translated in two dimensions.

The honeycomb is a unique structural configuration that offers many advantages such as good mechanical properties, excellent crushing properties, good acoustic properties, small cross-sectional area, and large exposed area within the cells. Materials with honeycomb structures are typically lightweight and stiff, and, as a result, exhibit good strength-to-weight ratios.

Materials with honeycomb structures may be made from almost any thin, flat material. Such materials with honeycomb structures have been made from many different web materials since the 1940s. Common web materials currently in use include (1) metals (aluminum, stainless steel, titanium, and nickel-based alloys), and (2) nonmetallic materials (fiber glass, Nomex® (E.I. du Pont de Nemours and Co., Wilmington, Del., U.S.A.), and Kraft paper). Less common web materials include copper, lead, asbestos, Kapton® (du Pont), Mylar® (du Pont), and Kevlar® (du Pont). Carbon fabric with a honeycomb structure is a material that has extremely high mechanical properties (including shear moduli as high as aluminum with a honeycomb structure), especially for a nonmetallic material. A honeycomb can be manufactured from a wide variety of materials, including nonmetallic materials (paper, graphite, aramid polymer, and fiberglass composites) and metallic materials (aluminum, corrosion-resistant steel, titanium).

Materials with a honeycomb structure are predominately used as a core in sandwiched structures. In such a “honeycomb sandwich construction,” two sheets of a thin, dense, strong material are bonded to a thick, lightweight honeycomb core. This produces-a material with beneficial strength-to-weight and stiffness-to-weight ratios.

Carbon nanotubes (CNTs) are cylindrical shells typically made by rolling graphene sheets into a seamless cylinder. CNTs may exist as either single-wall nanotubes or multi-walled nanotubes. They are very attractive materials for diverse nanotechnological applications because of their structural characteristics and their extraordinary electrical and mechanical properties (tensile strength on the order of 100 GPa, stiffness ca.1.000 GPa, and failure strain up to 0.4). In addition to these extraordinary properties, CNTs are an extremely lightweight material. They may be assembled into sheets. Recently, a CNT sheet with a width of 1 meter and a length of over 2 meters was reported. The CNT sheets are stronger than aluminum, but are less than half as dense.

Typically, CNTs are long, cylindrical molecules of carbon atoms that are arranged in a hexagonal lattice, as in graphite. Because carbon-carbon bonds are very stable and strong, and because CNTs are seamless and have a very small diameter (1-50 nanometers), CNTs have exceptional properties. High-quality CNTs have several times the strength of steel piano wire at one-fourth the density, at least five times the thermal conductivity of copper, and very high electrical conductivity and current-carrying capacity. CNTs have exceptional electronic, thermal, and mechanical properties; and a sheet formed by CNTs may have an extremely high surface area, diverse capabilities for chemical modification and functionalization, and strong interactions with polymers and composite host materials.

New methods and materials are needed to take advantage of the benefits of both the honeycomb structure and CNTs.

### BRIEF SUMMARY

Provided herein is a new material with a honeycomb structure made, at least in part, from CNT sheets. Generally, the material takes advantage of the honeycomb structure's properties, and CNTs' exceptional mechanical, thermal, and electrical properties. As a result, the material typically has a higher strength-weight ratio than other materials with honeycomb structures.

Also provided herein is a composite material including the material with a honeycomb structure made, at least in part, from CNT sheets, and at least one other material. In one embodiment, the at least one other material comprises two sheets, which may be any metallic or non-metallic material. In another embodiment, the material with a honeycomb structure made, at least in part, from CNT sheets is disposed between the two sheets. In some embodiments, the material with a honeycomb structure made, at least in part, from CNTs is affixed to the at least one other material. In some embodiments, the material with a honeycomb structure made, at least in part, from CNTs is not affixed to the at least one other material.

Also provided herein are methods for fabricating the new material with a honeycomb structure made, at least in part, from CNT sheets. Generally, two methods may be used to make the material: (1) the expansion process, and (2) the corrugated process.

In one embodiment, the material is made by a process that includes (1) applying at least one discrete portion of an adhesive to more than one carbon nanotube sheets; (2) stacking the carbon nanotube sheets; and (3) expanding the stack of carbon nanotube sheets. In another embodiment, the material is made by a process that includes (1) applying at least one discrete portion of an adhesive to at least one of two or more corrugated carbon nanotube sheets; and (2) stacking the corrugated carbon nanotube sheets.

### BRIEF DESCRIPTION OF THE DRAWINGS

FIG. 1 is a schematic illustration of a honeycomb structure.

FIG. 2 is a schematic illustration of a honeycomb panel (i.e. honeycomb plate) wherein the honeycomb is sandwiched between two thin sheets.

FIG. 3 is an illustration of a 9″×9″ CNT sheet in which the MWNTs in the sheet are randomly oriented.

FIG. 4 is a scanning electron microscopy (SEM) image at a 35° angle with respect to the forest plane, which captures a MWNT forest being drawn into the sheet; the higher magnification image shows the topology of the sheet.

FIG. 5 is a schematic illustration of a honeycomb before expansion block (HOBE) which is expanded into a honeycomb.

FIG. 6 is an image of CNT sheets in a honeycomb structure.

FIG. 7 is an SEM image of a carbon nanotube composite sheet which may be used to fabricate the material with a honeycomb structure formed from CNT sheets.

FIG. 8 is an SEM image of a carbon nanotube composite sheet which may be used to fabricate the material with a honeycomb structure formed from CNT sheets.

FIG. 9 is a schematic illustration of several of the various honeycomb structures described herein.

FIG. 10 is a schematic illustration of several of the various honeycomb structures described herein.

### DETAILED DESCRIPTION OF THE INVENTION

Provided herein is a material with a honeycomb structure made, at least in part, from CNT sheets. Generally, the material takes advantage of the honeycomb structure's properties, and CNTs' exceptional mechanical, thermal, and electrical properties. CNT sheets may be referred to as “buckypapers” by persons of skill in the art.

### The Material

The material generally has a honeycomb structure and is made, at least in part, from CNT sheets. In one embodiment, the honeycomb structure is made entirely from CNT sheets. In another embodiment, the honeycomb structure is made from at least one CNT sheet and at least one sheet of another substance. In certain embodiments, the other substance is a metallic, polymeric, or composite substance.

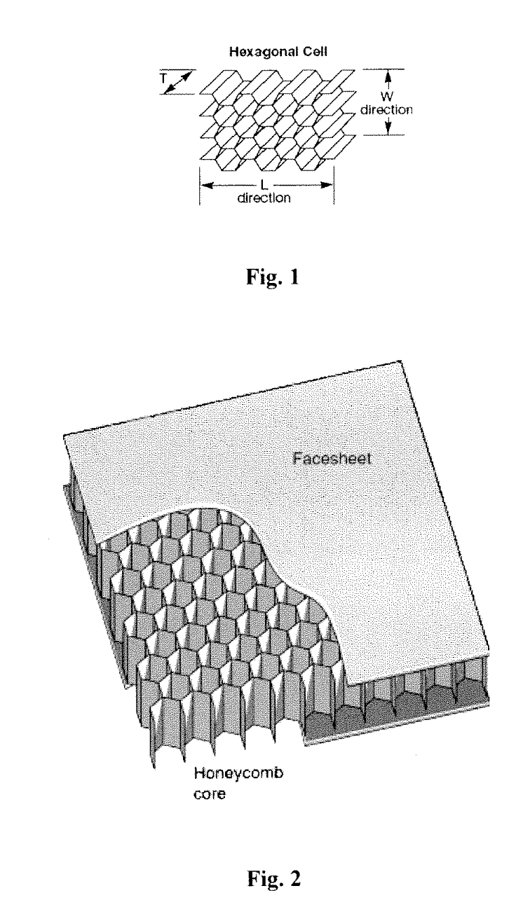

The cells in the honeycomb structures described herein may be of essentially any suitable shape. Typically, the honeycomb cells are non-circular. In some embodiments, the honeycomb cells are polygonal. In these embodiments, the cells may be triangular, square, pentagonal, hexagonal, heptagonal, or octagonal. Generally, the shape of the honeycomb cells may substantially comply with any of the shapes described herein. A schematic illustration of a honeycomb structure with hexagonal cells is shown in FIG. 1. Typically, the most common or basic cell shapes are the hexagon, square, and flex-core. In certain embodiments, the honeycomb structure is a reinforced honeycomb structure.

FIG. 1 also depicts the dimensions of the honeycomb structures described herein: the length (L), the width (W), and the depth (T) of the structure. Reference to the dimensions shown in FIG. 1 appear throughout the specification. While L denotes the length of the entire honeycomb structure, including all of its cells, the references herein to “cell length,” “length of the cell,” etc. refer to the length of the single wall in a particular cell that is aligned with the L direction of FIG. 1.

In some embodiments, the material with a honeycomb structure can be expanded or contracted. In one embodiment, the expansion or contraction can occur by applying a force to the material with a honeycomb structure. Generally, the application of an appropriate force—to either expand or contract the material with a honeycomb structure—may be used to adjust the shape of the cells and/or the dimensions of the material with a honeycomb structure.

Typically, any desired cell shape can be achieved, in part, by expanding or contracting the material with a honeycomb structure. In one embodiment, a force is applied to the material with a honeycomb structure in order to expand the material to obtain a desired cell shape. In another embodiment, a force is applied to the material with a honeycomb structure in order to contract the material to obtain a desired cell shape. In a further embodiment, the material with a honeycomb structure can be alternatively expanded and contracted until a desired cell shape is obtained.

In one embodiment, the material with a honeycomb structure can be contracted or expanded in the W direction (see FIG. 1). When contracted in the W direction, the width of the honeycomb structure decreases, and the length, L, of the honeycomb structure increases. When expanded in the W direction, the width of the honeycomb structure increases, and the length, L, of the honeycomb structure decreases. While, in some embodiments, the dimensions of the individual walls of the cells are fixed by the production method used to create the material with a honeycomb structure, expanding or contracting the honeycomb structure in the W direction can be used to alter the shape of the cells in the honeycomb structure. For example, contracting or expanding the honeycomb structure in the W direction can be used to create cells of various shapes, including, but not limited to, those in the overexpanded and underexpanded honeycomb structures of FIG. 10.

In another embodiment, the material with a honeycomb structure can be contracted or expanded in the L direction (see FIG. 1). When contracted in the L direction, the length of the honeycomb structure decreases, and the width, W, of the honeycomb structure increases. When expanded in the L direction, the length of the honeycomb structure increases, and the width, W, of the honeycomb structure decreases. While, in some embodiments, the dimensions of the individual walls of the cells are fixed by the production method used to create the material with a honeycomb structure, expanding or contracting the honeycomb structure in the L direction can be used to alter the shape of the cells in the honeycomb structure. For example, contracting or expanding the honeycomb structure in the L direction can be used to create cells of various shapes, including, but not limited to, those in the overexpanded and underexpanded honeycomb structures of FIG. 10.

In one embodiment, the material with a honeycomb structure may be expanded or contracted in order to control the flow of a gas or fluid through the honeycomb structure. Generally, the flow rate may be increased or decreased by either expanding or contracting the honeycomb to obtain a cell shape that permits the desired flow.

In one embodiment, the material with a honeycomb structure may be expanded or contracted in order to adjust the load bearing capability of the material. Persons of skill in the art understand that certain cell shapes are capable of bearing higher loads than others. Generally, the expandability and contractibility of the materials with honeycomb structures described herein allow for the load bearing capability to be maximized, if desired, by enabling the user to select an appropriate cell shape.

Generally, the expanding and contracting forces may be applied by any acceptable means. For example, the contracting force may be applied by squeezing the material with a honeycomb structure between two objects or surfaces, such as, for example, a vice. Similarly, the expanding force may be applied by pulling two sides of the material in opposing directions with the aid of tools, such as, for example, a clamp. Alternatively, the expanding or contracting forces may be applied by hand.

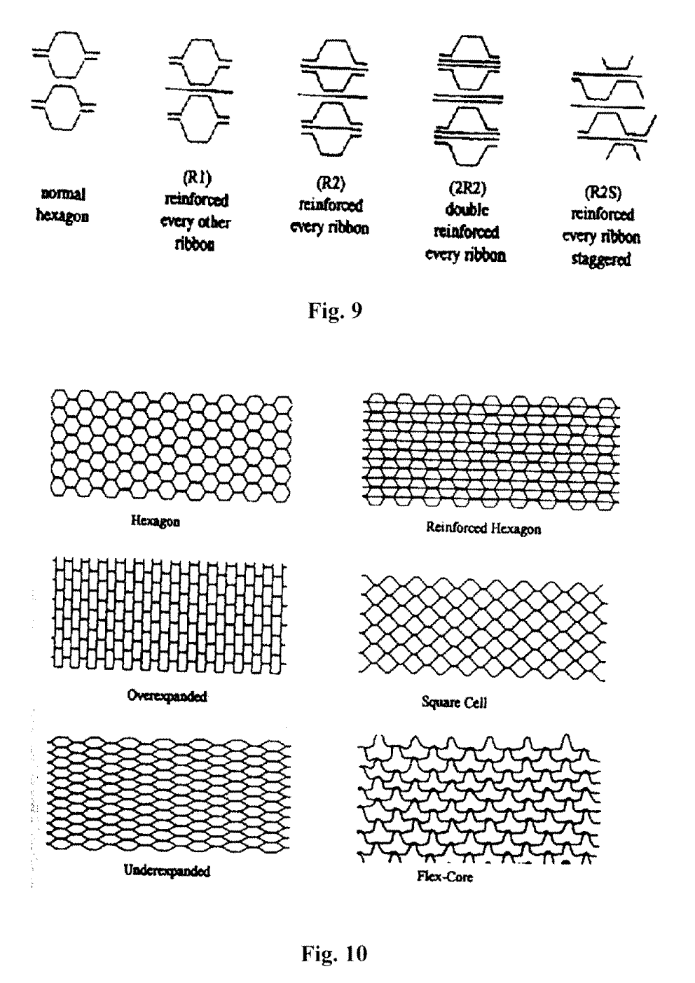

FIG. 9 also illustrates several of the various honeycomb structures that the material described herein may have. In addition to the hexagonal shape previously described, the honeycomb structure or the cells therein may have any of the following shapes: reinforced every other ribbon, reinforced every ribbon, double reinforced every ribbon, or reinforced every ribbon staggered. In one embodiment, the honeycomb structure has multiple rows of prismatic cells.

FIG. 10 also illustrates several of the various honeycomb structures that the material described herein may have: including hexagon, reinforced hexagon, overexpanded, square cell, underexpanded, and flex-core.

The thickness of the walls of the cells of the honeycomb structure is typically determined by the thickness of the CNT sheets. In some embodiments, the thickness of each sheet is from about 1 mm to about 10 mm. Therefore, in these embodiments, the thickness of the walls of the cells in the honeycomb structure is about 1 mm to about 10 mm. In some embodiments, one or more walls in the cells of the honeycomb structure will be formed from two sheets that are affixed to each other—therefore, some walls may have a thickness that is equal to the sum of the thicknesses of the two sheets.

In certain embodiments, the average diameter of the cells is from about 0.5 mm to about 5 mm, and the density of the honeycomb is between about 2 mg/cm³ and about 500 mg/cm³. In one embodiment, the honeycomb cell size, on average, is about 3 mm in diameter, the cell wall thickness is about 10 μm, and the density is about 0.013 g/cm³. Each of these parameters may be adjusted to satisfy the particular uses of the material.

### Composite Material

Also provided herein is a composite material made up of the material with a honeycomb structure made, at least on part, from CNTs, and at least one other material.

In one embodiment, the at least one other material includes two thin sheets. The two thin sheets may be any metallic or non-metallic substance. In this embodiment, the material with a honeycomb structure may be disposed between the two thin sheets to form a sandwich-like structure. In some embodiments, the material with a honeycomb structure may serve as the “honeycomb core” of the composite material: Such a composite material is depicted in FIG. 2, and is commonly referred to as a “honeycomb core sandwich,” “honeycomb plate” or “honeycomb panel.” Composite materials composed of stacks of two or more layers of honeycomb structure and three or more thin sheets (for example, in alternating layers) are also envisioned. In one embodiment, the two sheets are CNT sheets.

In certain embodiments, one or both of the two thin sheets may be any CNT sheet described herein. In one embodiment, the two sheets are made from carbon nanotubes and an other material. In one embodiment, the sheets contain 10-50% of an other material. In one particular embodiment, the other material is a polymeric material, such as those described herein. In one embodiment, the sheet contains a CNT sheet impregnated with a polymeric material. In one embodiment, the polymeric material is mixed with carbon nanotubes to form the sheets.

In some embodiments, the material with a honeycomb structure made, at least in part, from CNTs is affixed to the at least one other material. In some embodiments, the material with a honeycomb structure made, at least in part, from CNTs is not affixed to the at least one other material. Generally, when the other material is affixed to the material with a honeycomb structure, the other material may be used to apply a contracting or expanding force to the material with a honeycomb structure, especially if the other material is two sheets. When the other material is not affixed to the material with a honeycomb structure, the other material may be used to apply a contracting force to the material with a honeycomb structure, especially if the other material is two sheets.

In one embodiment, the at least one other material in the composite material is a polymer, or polymer solution. In certain embodiments, the polymer is disposed within one or more of the cells of the honeycomb structure. In other embodiments, the polymer is infiltrated into one or more of the CNT sheets used to make the material with a honeycomb structure. In still further embodiments, the polymer is disposed within one or more of the cells of the honeycomb structure and infiltrated into one or more of the CNT sheets used to make the material with a honeycomb structure.

Generally, the polymer may be any polymer that imparts the desired physical or chemical properties to the composite material, including, but not limited to, rigidity, strength, expandability, contractibility, heat resistance, or shape. In certain embodiments, the polymer is created by associating a pre-polymer with the composite material—for example, by infiltrating one or more of the CNT sheets—and polymerizing the pre-polymer to form a polymer. Generally, the pre-polymer may comprise any suitable monomer or oligomer. In certain. embodiments, the polymer may be any thermoplastic or thermosetting polymer, such as, for example, polyethylene, polypropylene, polystyrene, polyvinyl chloride (PVC), polymethylmethacrylate, polyacrylonitrile, polycarbonate (PC), epoxy resins, any co-polymer thereof, or any combination thereof. Therefore, if a pre-polymer is used, the pre-polymer may be any monomer or oligomer capable of creating a one of the thermoplastic or thermosetting polymers or co-polymers previously described.

In another embodiment, the at least one other material in the composite material is a polymer or polymer solution, and one or more thin sheets.

### Carbon Nanotube Sheets

Typically, CNT sheets are used to fabricate the materials with a honeycomb structure described herein. Generally, the CNT sheets are freestanding CNT networks, which are fabricated by either solution processes or solid state processes. Any method of fabrication known in the art, however, may be used to make the CNT sheets described herein.

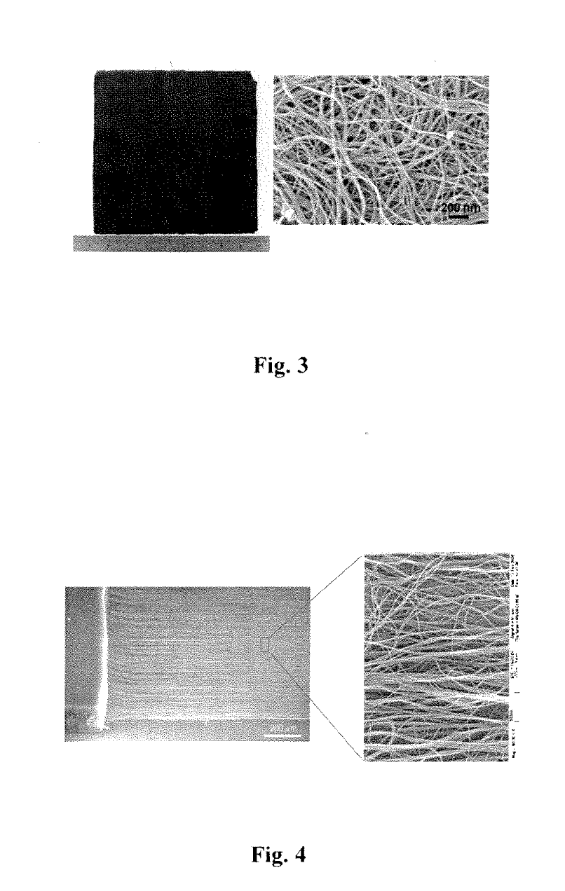

The solution processes involve dispersing CNTs in a solvent and assembling them into a sheet (commonly referred to as “buckypaper”) by vacuum filtration (FIG. 3), casting, spin coating, or spraying.

The solid state processes typically involve making CNT sheets by synthesizing CNTs using chemical vapor deposition (CVD), and assembling sheets by (1) directly collecting CNTs from the CVD process, (2) densifying the CNT forest, and (3) continuously pulling the CNT from the CNT forest (FIG. 4). The CNTs in the sheets may be oriented (i.e., aligned) (FIG. 4), partially oriented, or randomly distributed (FIG. 3).

The sheet may be formed by one sheet or several sheets stacked together, or laminated with certain orientations. The sheets may be formed by pure CNTs or CNT composites. In such CNT composites, the CNT concentration may be more than 50 wt %. The sheet also may be multilayered; the multiple layers may include pure CNT sheets, CNT composite sheets, or any combination of pure CNT sheets and CNT composite sheets. FIGS. 7 and 8 are SEM images of composite CNT sheets which may be used in any capacity described herein. Other CNT structured materials, such as CNT corrugated cardboard or sheets, may also be materials for making the material with CNT sheets with a honeycomb structure.

### Methods for Making the Material

Generally, the CNT honeycomb may be fabricated by using any suitable method known in the art. Such methods include, but are not limited to, the expansion method and the corrugated method.

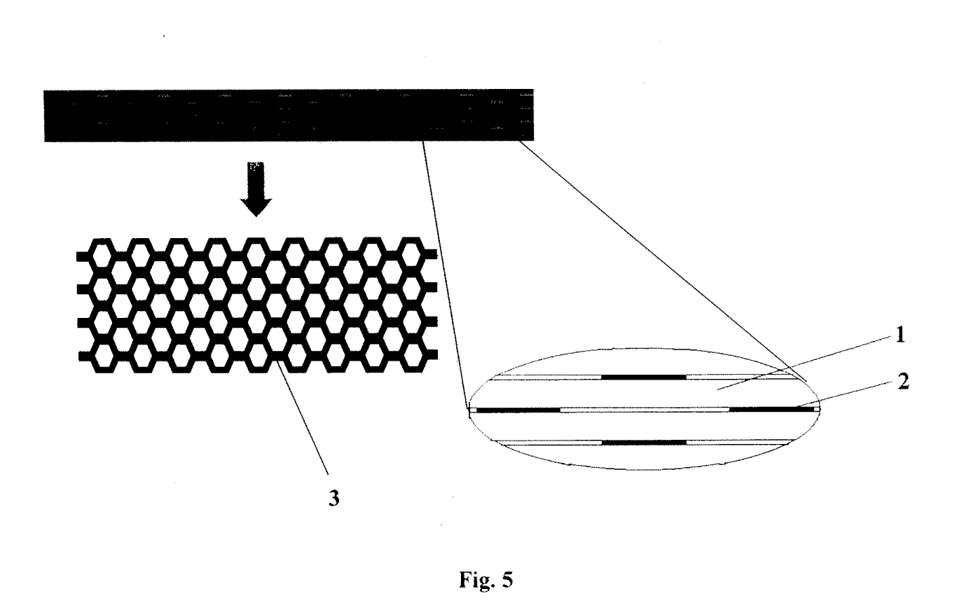

In one embodiment, the expansion method involves applying adhesive lines onto CNT sheets, stacking them, and curing the adhesive to form a HOBE (Honeycomb Before Expansion) block. The HOBE block is then expanded to produce a honeycomb structure, such as, for example, the hexagonal honeycomb structure schematically shown in FIG. 5. In another embodiment, the expansion method includes forming a HOBE block with sheets of CNTs and another substance. In certain embodiments, alternating sheets of CNTs and another substance are used to form the HOBE block.

In one embodiment, the HOBE block is formed by first applying lines of an adhesive to CNT sheets. In some embodiments, the length (L direction in FIG. 1) of each line of adhesive determines, at least in part, the dimensions of the honeycomb cells; if the lines of adhesive have a length of x, then the resulting cell walls will have a length of x. As shown in FIG. 5, the length of the line of adhesive 2 on the CNT sheet 1 corresponds to the length of the cell wall 3 that is formed upon expansion of the HOBE block. The depths (T in FIG. 1) of the lines of adhesive, in some embodiments, correspond with either (1) the depth (T of FIG. 1) of the CNT sheet to which the adhesive is applied or (2) a selected depth (T in FIG. 1) of the resulting material with a honeycomb structure. Once the adhesive is applied, the CNT sheets are stacked to form the HOBE block. In some embodiments, the CNT sheets are stacked so that the adhesive lines are offset in a manner that will produce the selected cell shape, as shown in FIG. 5.

In one embodiment, the HOBE-block is formed by stacking the sheets in a manner that will produce a hexagon-shaped cell upon expansion of the HOBE. In this embodiment, the general dimensions of each cell is determined by the length (L direction in FIG. 1) of the line of adhesive and the manner in which the adhesive lines are offset when the CNT sheets are stacked to form the HOBE block. In this embodiment, a hexagon-shaped cell is obtained by first selecting a length of the walls (L direction in FIG. 1) of the hexagon-shaped cells. Lines of adhesive having this length are applied to one side of the CNT sheets. The depth (T in FIG. 1) of each adhesive line may correspond to either the depth of the CNT sheet or to the desired depth, T, of the resulting material with a honeycomb structure. In this embodiment, the lines of adhesive should be spaced so that the lines of adhesive are separated, in the L direction (FIG. 1), by a distance equal to three times the selected length. The CNT sheets are then stacked so that the adhesive lines are offset. In this embodiment, the CNT sheets are stacked as shown in FIG. 5—the second sheet is stacked on the first sheet so that the adhesive lines on the second sheet are centered over the space between the adhesive lines on the first sheet. The remaining sheets are stacked in a similar manner so that the adhesive lines on the odd-numbered sheet align, but are offset with the adhesive lines on the even-numbered sheets, which also align. Generally, the number of CNT sheets used to form the HOBE varies, but enough sheets are stacked in order to achieve the desired width (W direction in FIG. 1) upon expansion. In this embodiment, the HOBE is expanded by applying a force that expands it in the W direction (see FIG. 1). Other alignments of the lines of the adhesives, which are capable of producing various cell shapes, are envisioned.

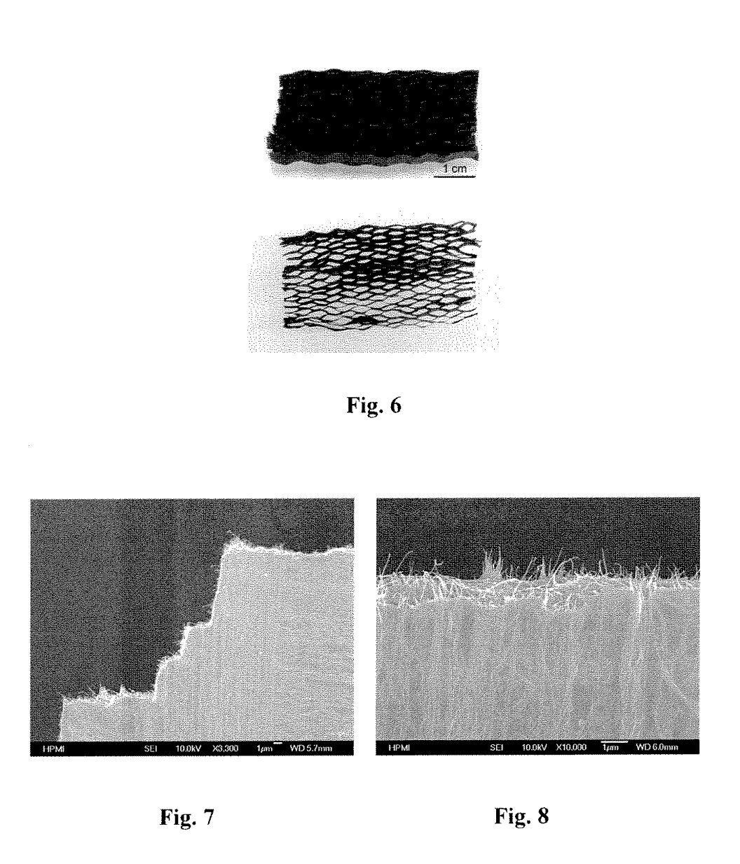

Generally, the expansion step can be used to produce a desirable shape of the cells or width or length (W and L directions, respectively, in FIG. 1) of the material with a honeycomb structure. An illustration of a material produced by this method is shown in FIG. 6. In another embodiment, the expansion method includes an additional step: contracting the material with a honeycomb structure to produce a desirable shape of the cells or width or length of the material.

In one embodiment, the corrugated process involves (1) applying adhesive to corrugated CNT sheets, (2) stacking the corrugated sheets into blocks so that the nodes align, thereby forming a honeycomb structure, and (3) curing the adhesive. The sheets can be cut to the required core thickness before processing. The cells in the honeycomb may have any of the configurations described herein. In another embodiment, the material made by this process may be expanded, contracted, and/or reinforced.

Generally, the corrugated sheets are configured so that their structures include a series of raised portions and depressed portions. The raised portions and depressed portions may be of any shape that allows the sheets to be affixed to one another to form a honeycomb structure. Typically, the raised portions and depressed portions are uniformly pointed, flat, or rounded. In some embodiments, the corrugated sheets contain a combination of pointed, flat, or rounded raised portions and depressed portions. A node, as used herein, is a region that encompasses the center point of each raised portion or depressed portion.

In one embodiment, the corrugated process involves (1) infiltrating a polymer or polymer solution into one or more CNT sheets, (2) placing the infiltrated CNT sheets into a corrugated mold, (3) curing or drying the polymer so that the infiltrated CNT sheets will maintain the shape of the mold, (4) applying adhesive to at least the nodes of the corrugated CNT sheets, (5) stacking the corrugated sheets into blocks, thereby forming a honeycomb structure, and (6) curing the adhesive. The cells in the honeycomb may have any of the configurations described herein. The sheets can be cut to the required core thickness before processing. Optionally, the cured or dried polymer may be removed from the material with the honeycomb structure so that it is expandable or contractable. Generally, as described herein, the expandability and contractibility of the material with a honeycomb structure allows for a desirable cell shape or height to be obtained.

In certain embodiments, the polymer is created by infiltrating a pre-polymer into the one or more CNT sheets, and polymerizing the pre-polymer to form a polymer. Generally, the pre-polymer may comprise any suitable monomer or oligomer. In certain embodiments, the polymer may be any thermoplastic or thermosetting polymer, such as, for example, polyethylene, polypropylene, polystyrene, polyvinyl chloride (PVC), polymethylmethacrylate, polyacrylonitrile, polycarbonate (PC), epoxy resins, any co-polymer thereof, or any combination thereof. Therefore, is a pre-polymer is used, the pre-polymer may be any monomer or oligomer capable of forming one of the previously-described thermoplastic or thermosetting polymers or co-polymers.

In certain embodiments, one or more corrugated sheets of another substance may be used in the corrugated process. Generally, the sheets of another substance may or may not be corrugated. In one embodiment, a sheet of another substance is disposed between two corrugated CNT sheets. For example, the sheets represented by the parallel lines in R2, 2R2, and R2S of FIG. 9 may be, in some instances, sheets of another substance.

The adhesive materials used in both processes may be any of those known in the art that offer the necessary bonding strength. The adhesive materials may include various dry and wet adhesive materials, including, but not limited to, commercially available Redux® pastes (Parker Laboratories, Inc. Fairfield, N.J., U.S.A.), which are epoxy adhesives that cure at room temperature and can also be cured at elevated temperature for higher levels of mechanical performance.

### Applications and Properties

The material with a honeycomb structure made, at least in part, from CNT sheets enjoys robust physical properties as described herein. The material is capable of supporting a load at least several thousand times heavier that the material's weight.

The material with a honeycomb structure made, at least in part, from CNT sheets and the composite material, especially the “honeycomb core sandwich structures,” are the state-of-the-art choice for weight sensitive applications such as aerospace, aircraft and satellite structures. The material with a honeycomb structure made, at least in part, from CNT sheets also can be used as a core structure in other transportation fields such as boat, yacht, van, marine, automotive, truck, and rail. In these applications, the material with a honeycomb structure made, at least in part, from CNT sheets can reduce body weight, increase speed, save energy, whilst providing strength and lessen vibration.

In the construction fields such as architectural, port, bridge, recreation, partition parts, ceiling, floor, and wall, the material with a honeycomb structure made, at least in part, from CNT sheets can speed project process, increase acoustic insulation, and save energy cost. The material with a honeycomb structure made, at least in part, from CNT sheets can provide special properties to cater to particular application requirements such as electronic or magnetic penetration, anti-chemical corrosion, anti-fire, anti-water, cleanness and others. In addition to sandwich planes for aircraft and architectural applications, the material with a honeycomb structure made, at least in part, from CNT sheets has many other applications such as energy absorption, thermal panels, acoustic panels, light diffusion and radio frequency shielding. The material with a honeycomb structure made, at least in part, from CNT sheets can also be used in devices for energy harvest. For example, the material with a honeycomb structure made, at least in part, from CNT sheets with sub-millimeter or micro-scale cells is an ideal electrode materials for fuel cells, batteries, and capacitors because it has extremely high surface area and is electrical conductive. In addition, the highly organized honeycomb cells can serve as channels for gases and fluids flow.

It will be of particular interest in fields, such as aerospace, where mass is at a premium and high surface area and well controlled structure are required.

These properties provide the material with a honeycomb structure made, at least in part, from CNT sheets with multi-functions more than a honeycomb made by other materials. For example; the material with a honeycomb structure made, at least in part, from CNT sheets could have compatible strength with Aluminum honeycomb, but advantageously at only half of the weight and at a higher service temperature capability. Comparing with nonmetallic materials, the material with a honeycomb structure made, at least in part, from CNT sheets is conductive and has much higher service temperature. The material with a honeycomb structure made, at least in part, from CNT sheets can be used not only in the mechanical strength, but also in devices for energy harvests because of the high surface area. The material with a honeycomb structure made, at least in part, from CNT sheets with sub-millimeter or micro-scale cells will be ideal electrode materials for fuel cells, batteries, and capacitors because it has high surface area and is electric conductive, as well as the organized channels for gases and fluids flow.

Modifications and variations of the methods and devices described herein will be obvious to those skilled in the art from the foregoing detailed description. Such modifications and variations are intended to come within the scope of the appended claims.

We claim:

1. A material comprising a honeycomb structure, wherein the honeycomb structure is formed, at least in part, from one or more carbon nanotube sheets.

2. The material of claim 1, wherein one or more cells in the honeycomb structure is non-circular.

3. The material of claim 2, wherein one or more cells in the honeycomb structure is polygonal.

4. The material of claim 3, wherein one or more cells in the honeycomb structure is triangular, square, pentagonal, hexagonal, heptagonal, or octagonal.

5. The material of claim 1, wherein the thickness of the walls of the cells in the honeycomb structure is about 1 mm to about 10 mm.

6. The material of claim 1, wherein the average diameter of the cells in the honeycomb structure is about 0.5 mm to about 5 mm.

7. The material of claim 1, wherein the material has a density from about 2 mg/cm³ to about 500 mg/cm³.

8. The material of claim 1, wherein the honeycomb structure is formed from at least one carbon nanotube sheet and at least one sheet of another substance.

9. The material of claim 1, wherein the material is expandable or contractible.

10. A composite material comprising:
a material comprising a honeycomb structure formed, at least in part, from one or more carbon nanotube sheets; and
at least one other material.

11. The composite material of claim 10, wherein the at least one other material is in the form of two or more sheets.

12. The composite material of claim 11, wherein the material comprising a honeycomb structure made, at least in part, from one or more carbon nanotube sheets is disposed between at least two of the sheets.

13. The composite material of claim 11, wherein the two or more sheets comprise carbon nanotubes.

14. The composite material of claim 11, wherein the honeycomb structure is formed from at least one carbon nanotube sheet and at least one sheet of another substance.

15. The composite material of claim 10, wherein the at least one other material comprises a polymer.

16. The composite material of claim 15, wherein one or more of the carbon nanotube sheets is infiltrated with the polymer.

17. The component material of claim 15, wherein the polymer is disposed within one or more of the cells of the honeycomb structure.

18. A method for making a material having a honeycomb structure comprising:
applying two or more lines of an adhesive to two or more carbon nanotube sheets, or to at least one carbon nanotube sheet and at least one sheet of another substance;
aligning the two or more carbon nanotube sheets, or the at least one carbon nanotube sheet and the at least one sheet of another substance, so that the two or more lines of the adhesive offset;
stacking the two or more carbon nanotube sheets, or the at least one carbon nanotube sheet and the at least one sheet of another substance to form a stack; and
expanding the stack to form the material having a honeycomb structure.

19. The method of claim 18, wherein the method further comprises:
contracting the stack to obtain a selected shape of the cells of the honeycomb structure.

20. The method of claim 18, wherein the honeycomb cells are about 3 mm in diameter.

21. The method of claim 18, wherein the thickness of the walls of the cells of the honeycomb structure is about 10 μm.

22. The method of claim 18, wherein the density of the material is about 0.013 g/cm³.

23. A method for making a material having a honeycomb structure comprising:
applying at least one discrete portion of an adhesive to two or more corrugated carbon nanotube sheets comprising a plurality of nodes, or to at least one corrugated carbon nanotube sheet comprising a plurality of nodes and at least one sheet of another substance; and
stacking the two or more corrugated carbon nanotube sheets, or the at least one corrugated nanotube sheet and the at least one sheet of another substance, so that the nodes align to form the material having a honeycomb structure.

24. The method of 23, wherein the adhesive is applied only to the nodes of the corrugated carbon nanotube sheets.

25. The method of claim 23, further comprising producing the two or more corrugated carbon nanotube sheets by a process comprising:
infiltrating a polymer or polymer solution into the two or more carbon nanotube sheets;
placing the infiltrated carbon nanotube sheets into a corrugated mold; and
curing or drying the polymer.

26. The method of claim 25, further comprising:
removing the cured or dried polymer from the material having a honeycomb structure.

27. The method of claim 26, further comprising:
expanding or contracting the material having a honeycomb structure to obtain a selected shape of the cells of the honeycomb structure.

28. The method of claim 23, wherein the at least one sheet of another substance is corrugated.
